(19) United States
(12) Patent Application Publication
(10) Pub. No.: US 2014/0089011 A1
(43) Pub. Date: Mar. 27, 2014

(54) Medication Management System

(71) Applicant: Xerox Business Services, LLC, Dallas, TX (US)

(72) Inventor: Denise L. Fletcher, Simsbury, CT (US)

(73) Assignee: Xerox Business Services, LLC, Dallas, TX (US)

(21) Appl. No.: 14/087,731

(22) Filed: Nov. 22, 2013

Related U.S. Application Data
(62) Division of application No. 13/316,138, filed on Dec. 9, 2011.

(51) Int. Cl. G06F 19/00

(52) U.S. Cl. CPC G06F 19/3456
USPC 705/3

(57) ABSTRACT

An apparatus comprising a processor configured to associate with a pharmacy or a doctor's office, obtain information regarding a medication for a patient, and send the information regarding the medication to a mobile device associated with the patient. A method for medication management comprising associating with a pharmacy or a doctor's office, obtaining information regarding a medication for a patient, and sending the information regarding the medication to a mobile device associated with the patient.

### CROSS-REFERENCE TO RELATED APPLICATION

This application is a divisional of U.S. patent application Ser. No. 13/316,138 filed Dec. 9, 2011 and entitled “Medication Management System” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Generally, a prescription is a health-care program implemented by a physician or other medical practitioner in the form of instructions that govern the plan of care for an individual patient. Prescriptions may include orders to be performed by a patient, caretaker, nurse, pharmacist, or other therapist. Commonly, the term prescription is used to mean an order to take certain medications. Prescriptions have legal implications, as they may indicate that the prescriber takes responsibility for the clinical care of the patient and in particular for monitoring efficacy and safety. A prescription medication or prescription drug is a licensed medicine that is regulated by legislation to require a medical prescription before it can be obtained. The term is used to distinguish it from over-the-counter drugs which can be obtained without a prescription. Different jurisdictions have different definitions of what constitutes a prescription drug. Dispensation of prescription drugs often includes a prescription order or form, also referred to as a medical or drug prescription or simply a prescription, which gives detailed information about the drug.

### SUMMARY

In an embodiment, the disclosure includes an apparatus comprising a processor configured to associate with a pharmacy or a doctor's office, obtain information regarding a medication for a patient, and send the information regarding the medication to a mobile device associated with the patient.

In another embodiment, the disclosure includes a method for medication management comprising associating with a pharmacy or a doctor's office, obtaining information regarding a medication for a patient, and sending the information regarding the medication to a mobile device associated with the patient.

In yet another embodiment, the disclosure includes a non-transitory computer-readable medium having computer usable instructions stored thereon for execution by a processor. The instructions cause the processor to associate with a pharmacy or a doctor's office, obtain information regarding a medication for a patient, and send the information regarding the medication to a mobile device associated with the patient.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a medication management system.

FIG. 2 is a flowchart of an embodiment of a medication management method.

FIG. 3 is a schematic diagram of an embodiment of a radio unit.

FIG. 4 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In many cases, a patient may have a plurality of prescribed and non-prescribed medications, drugs, herbal remedies, vitamin regime, other undertaken treatments, or combinations thereof by one or more physicians over the same period. As used herein, the term medication may comprise medical drugs, but may also comprise other prescribed medical treatment products, such as medical pads, bandages, sprays, lotions, or any other type of products used for medical treatment. Multiple physicians may assign a patient multiple prescriptions and/or treatments, but the physicians may not share the prescription and/or treatment information with each other. Further, different pharmacies that fill the prescriptions may not use a common database for sharing the prescription information. Thus, the patient may have the responsibility of maintaining his/her assigned prescriptions/treatments instead of the physicians or pharmacies.

The patient may need to keep track of the assigned prescriptions/treatments to guarantee proper treatment and medication consumption as instructed or recommended by physicians and indicated in the prescription information. Keeping track of assigned prescriptions/treatments may also allow the patient to avoid any interactions that may arise from prescribing and consuming different medications (e.g., prescription drugs) within the same period. The patient may need to show a list of current assigned prescriptions/treatments to a physician before the physician assigns a new medication/treatment to the patient. The physician may want to see the list to avoid assigning interacting medication that may cause side effects to the patient's health when taken with any of the current assigned prescriptions. Alternatively, the patient may need to carry all current prescribed medications/treatments (e.g., in a bag) to the physician's office or attempt to remember and site all the medications he or she is currently prescribed.

Maintaining a current updated list of assigned prescriptions/treatments may pose challenges to the patient, such as when the patient keeps track of the list manually, e.g., by writing text on a paper notebook or entering (typing) text on a computer. For example, the patient may fail to enter a prescription or may unintentionally enter wrong information, such as date, time, or drug portion information. Thus, the list may be incomplete or include erroneous information. Further, manual entry may become task intensive, such as when a substantial number of medications are prescribed at the same period, which may become a burden on the patient.

Disclosed herein is a system and method for allowing patients to efficiently and conveniently collect information about assigned prescriptions and treatments using mobile personal devices, such as smartphones. The system may be used to enter and maintain prescriptions and treatment information in a convenient manner, e.g., without direct and manual entry by the user (patient). The mobile device may be equipped with a wireless communications module that may be used to communicate the prescription information without manual user entry. The system may also issue alerts when interactions in prescriptions are detected, such as when there is a potential adverse reaction to consuming different medications at the same period. The system may also share the patient's prescription information with physicians and/or pharmacy databases and may issue alerts if needed or requested to such entities. The system may maintain a comprehensive list of patient's assigned prescription and related information, and hence eliminate the need to attach or staple patient prescription information on purchased medication.

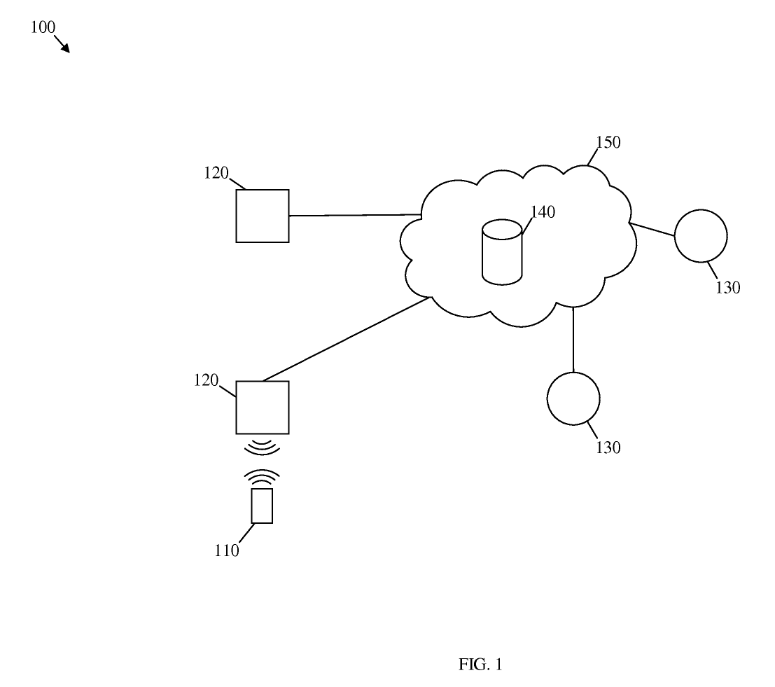

FIG. 1 illustrates an embodiment of a medication management system 100, which may use a mobile device to enter and maintain user medication information without direct and manual user entry. The medication may include prescription medication, non-prescription (e.g. over-the-counter) medication, health supplement products (e.g., vitamins and/or herbal supplements), and other treatments or activities that may interact with the aforementioned medications (e.g. consumption of food, consumption of alcohol, strenuous activity, etc.). The medication management system 100 may comprise one or more mobile devices 110, one or more transaction points 120, one or more access nodes 130, a medication management database 140, and a network 150 arranged as shown in FIG. 1. The components of the medication management system 100 may be distributed along a plurality of geographical locations or sites. For example, the transaction points 120 may be located at different medication supplier sites or stores (e.g., pharmacies), and the access nodes 130 may be located at different physician offices, clinics, hospitals, or healthcare provider sites. The different locations or sites may be distributed across regions, such as towns, cities, states, and/or countries.

The mobile devices 110 may be any mobile and personal devices configured to manage medication information. The mobile devices 110 may be operated by corresponding registered users (e.g., patients). The mobile devices 110 may comprise wireless access technologies or interfaces (e.g., in a chip or component) that enable the mobile devices 110 to establish wireless links with the transaction points 120. The mobile devices 110 may communicate with the transaction points 120 to exchange medication information and/or related alerts. The mobile devices 110 may also communicate with the access nodes 130, e.g., via the transaction points 120 and the network 150 or via any other network or interface. In some embodiments, the mobile devices 110 may also communicate with the database 140, e.g., via the transaction points 120 and the network 150 or via any other network or interface. The mobile devices 110 may also communicate with the access nodes 130 to authenticate, exchange medication information and/or exchange alerts. Examples of wireless technologies and interfaces that may be used in the mobile devices 110 (and correspondingly in the transaction points 120 and/or the access nodes 130) include a Bluetooth interface, an Institute of Electrical and Electronics Engineers (IEEE) 802.11 compliant (or WiFi™) wireless interface, a near field communication (NFC) link, an Infrared Data Association (IrDa) interface, a Radio-frequency identification (RFID) interface or a radio frequency transponder, a reflective antenna chip (electronic tag), cellular interface (e.g., third Generation Partnership Project (3GPP) interface), and/or any other wireless technology interface that may be applicable.

A single mobile device 110 may comprise one or more wireless technology interfaces (components) that may communicate with one or more transaction points 120. The mobile devices 110 may comprise visual displays (or display screens) that allow the users (patients) to view and enter information (e.g., medication information) on the mobile devices 110. The mobile devices 110 may also comprise other types of input/output (I/O) interfaces, including a touch screen or physical keyboard, a microphone, a camera, a speaker, wireless interfaces, infrared interfaces, and/or other I/O interfaces. The mobile devices 110 may also comprise chargeable batteries that may power the mobile devices 110. Examples of the mobile devices 110 may comprise smartphones, laptop computers, tablet computers (or pads), electronic book (ebook) readers, and other mobile or personal devices that may be used to communicate wirelessly with the transaction points 120 and allow the patient to view/enter medication information.

The transaction points 120 may be any systems, devices, or components configured to establish wireless communications with the mobile devices 110. The transaction points 120 may be operated or supervised by trained or in-charge personnel, such as pharmacists, or by automated systems, such as medical dispensary vending machines. The transaction points 120 may comprise computer or similar devices that may use wireless technologies or interfaces to communicate with the mobile device 110, as described above. Examples of the devices at the transaction points 120 may include desktop computers, laptop computers, and/or terminal equipment (e.g., keyboards and computer screens) that may be coupled to servers (e.g., in the network 150). The devices may also include relatively short to middle range wireless communications devices that may use the wireless technologies above to exchange information with the mobile devices 110. The transaction points 120 may be linked to the network 150 via wireless and/or fixed (wired) links. The transaction points 120 may communicate with each other and/or share information (e.g., in the medication management database 140) via the network 150. The transaction points 120 may also communicate with the access nodes 130 (e.g., via the network 150). The transaction points 120 may be located in authorized medication suppliers, such as pharmacies and/or any other types of medical dispensaries (e.g., in clinics, hospitals, or other healthcare providers). In some embodiments, the transaction points 120 may comprise base transceiver stations (BTS) in cellular networks.

The access nodes 130 may be any systems, devices, or components configured to provide access to medication information of patients (e.g., of the mobile devices 110) and/or send medication information (e.g., prescription medication forms) to the mobile devices 110. The access nodes 130 may be transaction points operated or supervised by physicians and/or authorized staff or by the user (e.g., patient). The physicians may use the access nodes 130 to access the patient's medication information (e.g., in the medication management database 140 or local storage of the transaction points 120) via the network 150 and/or to prescribe medication to patients, e.g., by sending electronic medication forms to the mobile devices 110. The access nodes 130 may comprise computers or similar devices, such as desktop computers, laptop computers, and/or terminal equipment (e.g., keyboards and computer screens) that may be coupled to servers (e.g., in the network 150). The devices may also include relatively short to middle range wireless communications devices that may use the wireless technologies above to exchange information with the mobile devices 110. The access nodes 130 may also communicate with the mobile devices 110 via the network 150 and/or other networks or interfaces. The access nodes 130 may be linked to the network 150 via wireless and/or fixed (wired) links and may communicate with one another to share information via the network 150 and/or with the transaction points 120. The access nodes 130 may be located at healthcare provider locations, such as physicians' offices, clinics, hospitals, emergency rooms, and/or any other healthcare provider sites.

In some embodiments, the mobile device 110 may be configured to exchange any of the information described above with the transaction points 120 and/or the access nodes 130 via communications means other than wireless communications. For instance, the mobile device 110 and similarly the transaction point and/or the access node 120 may be equipped with a Universal Serial Bus (USB) port that may connect to a USB memory card to exchange information that may be stored on the USB memory card. Thus, the mobile device 110 may exchange the information above by swapping a USB memory card with the transaction points 120 and/or the access nodes 130. Other storage devices and/or wired communications means may also be used to exchange the medication/treatment information, such as a USB cable.

The network 150 may be any network that communicates with and allows communications between the mobile devices 110, the transaction points 120, and the access nodes 130. The network 150 may also exchange information with the mobile devices 110 via the transaction points 120 and/or the access nodes 130, or directly with the mobile device 110. The network 150 may comprise one or a plurality of access/transport networks that may be based on one or more network transport technologies and protocols. Examples, of the network 150 may include the Internet, Ethernet networks, optical backbone networks, digital subscriber line (DSL) networks, local area networks (LANs), wireless area networks (WANs), other types of telecommunication networks, or combinations thereof.

The medication management database 140 may be any device, apparatus, or component configured to store medication information of patients (e.g., of the mobile devices 110) in the network 150. The medication management database 140 may comprise a storage medium, such as one or more disk storages, that stores and maintains patient medication data, such as a national drug database or a private drug supplier database (a pharmaceutical company database). The medication data may include patients' medication form data and filled medication information. The medication management database 140 may also store patient related data, which may include patient personal/profile information and healthcare/insurance data. The medication management database 140 may communicate with the transaction points, the access nodes 130, and/or the mobile devices 110 to exchange and update the stored information. In an embodiment, the medication management database 140 may be distributed at a plurality of sites coupled to the network 150, such as at least at some of the transaction points 120 and/or access nodes 130. As such, the distributed medication management database 140 may comprise a plurality of medication management databases located at the different locations. In another embodiment, the medication management database 140 may be located on the mobile device 110.

Additionally, the mobile device 110 may host a medication management application (e.g., a program or software) that may be configured to handle a plurality of operations and functions related to entering, maintaining/managing, and communicating medication information, and similarly other treatment information. For instance, the mobile device 110 may be a smartphone (e.g., an IPhone™ or Android™ based smartphone) that hosts a smartphone application (e.g., an iPhone™ App). The medication management application may be downloaded and installed on the mobile device 110 via the Internet or via other means. The operations and functions of the mobile device 110 and/or the medication management application may include patient-device registration, entering medication information, displaying medication information, sending/receiving medication related alerts and notifications, and/or other functions as described in detail below. In some embodiments, another version of the medication management application may also be installed on the transaction points 120 and/or the access nodes 130. For example, a medication management agent application may be used on the transaction points 120 and/or the access nodes 130 to communicate with the medication management application on the mobile device 110.

The medication management application may comprise a function for patient-device registration, which may allow registering a patient (user) with the mobile device 110. This function may be selected using the medication management application, e.g., by selecting this function in a menu or by selecting/clicking on a corresponding button. To register, the patient may use patient identification information, such as an access code, a personal identification number (PIN), a user identifier (ID), a user login name, a user password, and/or other user identification means that identifies the patient as the user of the mobile device 110. The patient may need to register with the mobile device 110 using the medication management application before using the operations and functions for handling and managing the medication information. The patient may use the medication management application (after installing the application on the mobile device 110) to implement the registration process and/or use the mobile device 110 or any other communication device (e.g., computer) to access an online web page/site for registration.

During registration, the patient may enter some registration information in a registration form (in the application or the web site), including personal profile information (e.g., full name, phone number, email, address, and/or other personal information). The registration process may also include entering or registering a user name (login name) and password and/or other authentication information for the patient (e.g., PIN). The authentication information may be used to associate the patient with the mobile device 110. The medication management application may create an account for the patient after registration. The account may comprise the patient's registration information. A plurality of patients may be registered with same device using a plurality of separate accounts. Each patient may only be allowed to access his/her corresponding account on the medication management application using the corresponding authentication information.

After registration, the authentication information may be used to authenticate and verify the identity of the user of the mobile device 110 as the registered patient before authorizing the user to use the medication management application and the medication related functions. For instance, the user may be prompted to enter (or log-in) the authentication information every time before activating or using the medication management application or a medication related function on the mobile device 110. Alternatively, the patient may select to remain logged in to the medication management application without the need to re-enter the authentication information every time. The registration information may be edited or changed by the registered patient at any time (e.g., during or after registration).

In some embodiments, the mobile device 110 may be equipped with a camera, scanner, or other device that may be used to scan or otherwise capture biometric data for the patient during registration, such as a face picture, a retina scan, or a thumb print scan. The registered biometric data may subsequently be scanned to authenticate the user before enabling the medication management application and related functions. Additionally or alternatively, the mobile device 110 may be equipped with a microphone that may record the patient voice for audio/voice identification. In some embodiments, the mobile device 110 may comprise a reflective antenna chip (electronic tag) or a radio frequency transponder that may be scanned at the transaction point 120 to identify and authenticate the mobile phone 110 and its user. In an embodiment, the mobile device 110 may be equipped with a Global Positioning System (GPS) that may be used to verify the location of the mobile device 110 before enabling the medication management application and related functions. The GPS module may be used to detect the mobile device's geographic location and match the detected location with a set of authorized locations, which may be registered by the patient during the registration process. The authorized locations may include any number of cities, states, regions, or countries that may be registered by the patient.

The patient may also enter during registration his/her healthcare and insurance number and optionally other related information. Registering healthcare and insurance information may associate the patient's healthcare account with the mobile device 110, the medication management application, and any entered medication information. The medication management application may also be linked to or associated with a healthcare application, which may also be a smartphone application. Thus, the medication management application and the healthcare application may exchange medication, medical, and/or healthcare information. In an embodiment, the healthcare application may be the Benefits Genie™ application developed by Buck Consultants, limited liability company (LLC). Benefits Genie™ is a smartphone application (e.g., available as an iPhone™ App) intended for employee access (by smartphone) to employer health and retirement plan information and employee related data. In Benefits Genie™, the data and other confidential information may be accessed upon authorized communication (e.g., a combination of phone ID and employee ID, password, and/or PIN security questions). Upon recognizing the user and authorizing his/her access, the data may be delivered to the smartphone by separate feeds from employer database and outside contracted data sources. The feeds may be joined (by the healthcare application) to provide employee-specific information. The accessed data may be erased from the smartphone upon discontinuing the access or closing the application.

The medication management application may comprise a function for entering medication information on the mobile device 110. The medication information may be received/entered using the medication management application, e.g., by selecting this function in a menu or by selecting/clicking on a corresponding button. For instance, a medication form comprising medication and dispensation information may be downloaded or received on the mobile device 110 (e.g., from a physician office) using the medication management application, e.g., via email or other wireless communications means, such as cellular or other long range wireless communications. The medication and dispensation information may comprise medication name, a dosage level, a dosage frequency, refilling information including a maximum number of refills, and/or other medication and dispensation related information. The mobile device 110 may receive the medication form from the access node 130 (e.g., at the physician office). The user or patient may also use the medication management application to enter the medication form information directly on the mobile device 110, such as by typing the information on a touch screen or physical keyboard or by voicing the request using a microphone. The medication management application may then be used to exchange the medication and dispensation information (in the medication form) with the transaction point 120 (e.g., at the pharmacy) to fill the medication and hence obtain the prescribed medication. The patient's medication may be filled electronically using a wireless connection between the mobile device 110 and the transaction point 120. For instance, a wireless link may be used to send the filled medication information from the transaction point 120 to the mobile device 110, such as a Bluetooth connection, a WiFi™ connection, a NFC connection, or an IrDa connection.

When the medication is filled electronically on the mobile device 110, the mobile device 110 may receive filled medication information from the transaction point 120, e.g., via any of the wireless links above. The medication management application on the mobile device 110 may allow the user (e.g., patient) to enable or disable receiving the medication information. In some scenarios, the user may enter the medication information on the mobile device 110, e.g., if the pharmacists cannot do so. For instance, the medication information may be entered on the mobile device 110 manually by the user (e.g., via typing on a manual input device, such as a keyboard, mouse, track-pad, stylus, or touch-screen), RFID reading from the medication bottle or package, camera capturing (of the information on the bottle or package), or other entry input means on the mobile device 110. In some embodiments, the patient's primary care physician or the physician that prescribed the medication may also receive similar information via the access node 130. The physician may use another version of the medication management application hosted on the access node 130 to receive the medication information. The medication management application on the access node 130 may allow the physician to enable or disable receiving the medication information. As such, the physician may have an efficient manner of acquiring medication information, and hence building a medication database for his patients, which may allow the physician to better monitor the treatment and health of his patients.

The medication information may comprise medication name, manufacturer information, suggested use instructions, expiration date, storage information, side effects, warning information (e.g., when to take or not to take medication), interactions with other medications, amount per serving, ingredients, and/or other medication related information. The medication information may be sent to the phone via the wireless link from the transaction point's local or remote database (e.g., the medication management database 140). In one embodiment, a barcode or electronic tag on the medication box or package may be scanned by the mobile device 110 when the medication is filled to download the medication information. When the barcode or electronic tag is scanned, the medication management application may identify the medication and obtain the corresponding medication information, e.g., from an online drug information database. For example, the mobile device 110 may connect to the Internet to obtain the medication information using a data connection based on any wireless technology. Alternatively, a picture of the medication box or package may be captured using a camera of the mobile device 110 and used to identify the medication (using image/text recognition techniques) and hence obtain medication information. The information may be downloaded onto the mobile device 110 using the medication management application, which may replace the need to include medication information in written format, such as a drug information sheet that is typically provided with medication in a box or package.

The medication management application may comprise a function for displaying the medication information function, which may be selected in a menu or by selecting/clicking on a corresponding button in the medication management application. The user may use this function to display and view medication information on the mobile device screen or a screen coupled to the mobile device 110. For instance, the user may select to display dispensing information including the medication name and the dosage frequency. In some embodiments, the user may also have an option to listen to an audio reading of the information on the mobile device 110 via a speaker, print the information by connecting the mobile device 110 to a printer, transfer the information to another device via a wired or wireless link, email or text (e.g., via short message service (SMS)) medication information, or combinations thereof. The medication management application may present summarized, concise, and/or filtered information to the user, e.g., based on user (patient) preference. For example, the medication management application may filter out and display the side effects information from the remaining medication information, if the user selects such a filter. A word spotter may be used to identify and filter the information to be displayed to the user, for instance based on keywords indicated by the user, e.g., “side effects” or “drug transactions”. In another example, the user may select to view only medication information related to a certain health condition, such as heart medication information. The filter options may be changed by the user at any time to view more or different information in the medication management application.

The medication management application may be configured to obtain medication information for a plurality of filled medications. For example, the medication information for different filled medications may be downloaded and stored on the mobile device 110. Alternatively, a plurality of links or pointers to information about the different filled medications may be maintained on the mobile device 110, where the information about the different filled medications is actually stored outside the mobile device 110 (e.g. at the medication management database 140). The links may be used by the medication management application to obtain (e.g., via a wireless link) the corresponding medication information for different filled medications, e.g., from the medication management database 140 or a plurality of corresponding remote databases. Similarly, the medication management application may maintain or store issued medication information, e.g., electronic medication forms.

The medication management application may comprise a function for sending/receiving medication related alerts and notifications, which may be configured by the user. The function may be accessed in the medication management application in a menu or by selecting/clicking on a corresponding button. The medication management application may analyze the medication information (in electric medication forms) and the medication information (for filled medications) to provide relevant alerts and/or notifications. The alerts may comprise urgent information, and the notifications may comprise less urgent information that may be of interest to the user. The medication information may be analyzed to send alerts and notifications based on user indicated preferences and options. The user may configure or set the preferences and options using this function of the medication management application. The function may also be used to enable or disable some of the notifications and alerts if the user chooses to. In some embodiments, other versions of the medication management application on the transaction points 120/access nodes 120 may also comprise a function for sending/receiving medication related alerts and notifications, which may be similarly configured (e.g., by pharmacists/physicians).

The medication information may be analyzed or processed by the medication management application to detect or identify expiration and/or upcoming refill dates if such option is selected by the user. The user (patient), his/her physician, and/or pharmacist may be notified if the medication is about to expire or the maximum allowed number of refills will be reached. The entities may also be alerted if the medication has expired or the maximum allowed number has been reached. The medication information may also be analyzed to determine whether any interactions, such as health side effects, may arise from consuming two or more currently prescribed medications. The user (patient), his/her physician, and/or pharmacist may be notified if the electronic medication forms correspond to such interacting medications. The entities may also be alerted if the medications were filled for such interacting medications. The medication information may also be analyzed to determine available or relatively close transaction points 120 (e.g., pharmacies) to a patient's registered local region, e.g., based on indicated user location preferences. The user (patient) may be notified of a list of such locations or may be alerted when the mobile device 110 is within a determined range of one of the locations (e.g., using GPS data).

The analysis may also be used to provide the user with medication options or alternatives, such as medications similar to the prescribed medications (e.g., by different manufacturers) that may have lower prices or may avoid interactions with current medications. For instance, the medication management application may obtain insurance information to determine alternative medications that have lower prices and/or fewer interactions with current medications. The user (patient), his/her physician, and/or pharmacist may be notified of a list of alternative medications or drugs based on the medication information of the medication management application. In some embodiments, the specification and medication information may be analyzed jointly with associated healthcare insurance information (e.g., using exchanges with a second application on the mobile device 110) to recommend medication to the user, his/her physician, and/or pharmacist.

The medication management application may send notifications and alerts via text, email, or any display/audio alert message or tone supported by the mobile device 110. The alerts and notifications may also be sent via voice calls to a registered patient's number, physician number, and/or pharmacy number. The user may enter or set parameters in the medication management application to determine when and/or how to send the notifications. The parameters may also include triggers or conditions that may cause the medication management application to send such notifications. For example, the user may select to send a list of current or alternative medications on a periodic basis, e.g., at the beginning of the month, or when a new medication is issued (by the physician) or filled (by the pharmacy).

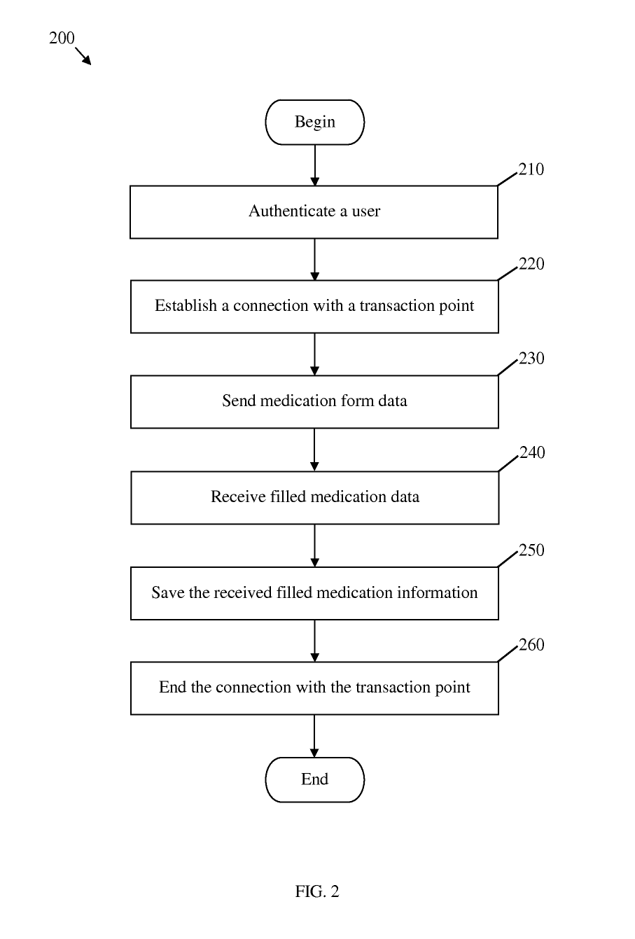

FIG. 2 illustrates an embodiment of a medication management method 200, which may be implemented on a mobile device that hosts a medication management application, as described above. The method 200 may be implemented to establish and complete a medication transaction between the mobile device (e.g., mobile device 110) and a transaction point (e.g., transaction point 120) to fill a medication. Similarly, the method 200 handle other treatment information, e.g., in combination with the medication application. The method 200 may begin at block 210, where a user may be authenticated. The user of the mobile device may be authenticated to identify the user as a registered patient of the mobile device and hence allow the user to access and use the medication management application. The user may enter authentication information such as user name and password or may be authenticated using any of the schemes described above. At block 220, a connection may be established with the transaction point. The mobile device may use any of the wireless technologies described above to establish a wireless link with the transaction point. The link may be established automatically by the medication management application (after user authentication), when the mobile phone is sufficiently within range with the transaction point. Alternatively, the user may be prompted to allow the mobile device to connect to the transaction point. In an embodiment, the medication management application may communicate with a corresponding application (agent application) at the transaction point to establish the wireless link.

At block 230, medication form data may be sent. The user may use an option of the medication management application to select an indicated electronic medication form and send the medication information to the transaction point. The medication form may have been received and downloaded previously on the mobile device, e.g., via email or a wireless link with an access node (e.g., access node 130). The medication information may be sent to the transaction point via the established connection. At block 240, filled medication data may be received. The mobile device may receive the filled medication form information from the transaction point over the connection. The filled medication information may be entered or handled by the operator of the transaction point, e.g., a pharmacist, and may be subsequently sent from the transaction point to the mobile device. The information sent may be obtained or forwarded from a local or remote medication database (e.g., medication management database 140) that may be coupled to the transaction point. The filled medication information may be received automatically by the medication management application. Alternatively, the user may be prompted to allow the mobile device to receive the information from the transaction point.

At block 250, the received filled medication data may be saved. The medication management application may save the received filled medication information on the mobile device automatically or by prompting the user and receiving an acknowledgement from the user to save the data. At block 260, the connection may be ended. The connection may be ended automatically when the user walks away from the transaction point and hence the mobile device exits the wireless connection range. Alternatively, the user may interactively end the connection between the mobile device and the transaction point by using an option of the medication management application. The method 200 may then end.

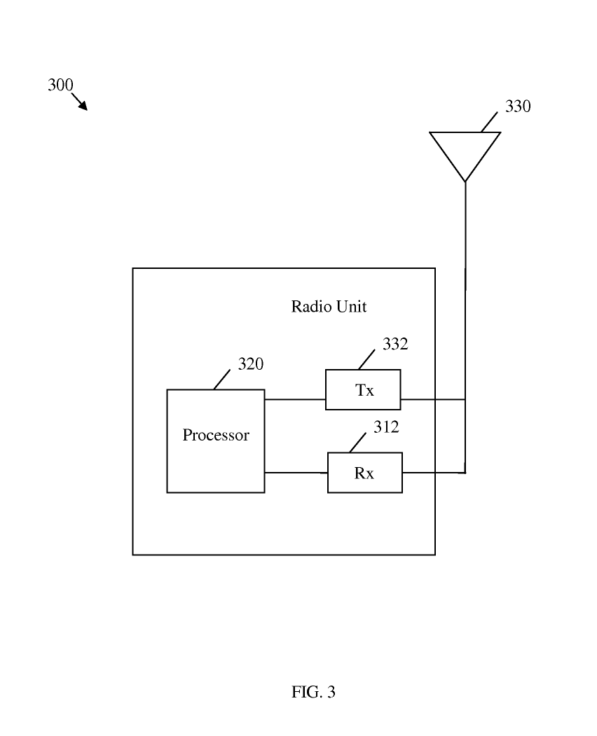

FIG. 3 illustrates an embodiment of a radio unit 300, which may be any device that communicates data (e.g., packets) wirelessly with a network. For instance, the radio unit 300 may be located in a mobile device (e.g., mobile device 110) that exchanges or communicates data with networks or other mobile devices. The radio unit 300 may comprise a receiver 312 (Rx), which may be configured for receiving data, packets, or frames from other components. The radio unit 300 may comprise a logic unit or processor 320 coupled to the receiver 312, which is configured to process the data and determine to which components the data is to be sent. The logic unit or processor 320 may also be configured to support or implement the medication management application and the medication management method 200. The logic unit or processor 320 may be implemented using hardware, software, or both. The radio unit 300 may also comprise a transmitter 332 (Tx) coupled to the logic unit or processor 320 and configured for transmitting data, packets, or frames to other components.

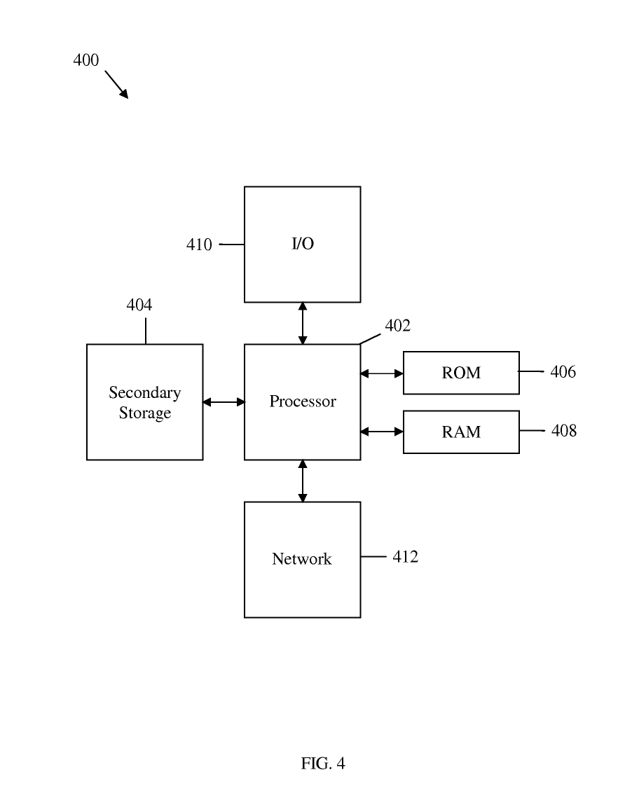

The components described above may be implemented on any general-purpose network component, such as a computer or network component with sufficient processing power, memory resources, and network throughput capability to handle the necessary workload placed upon it. FIG. 4 illustrates a typical, general-purpose network component 400 suitable for implementing one or more embodiments of the components disclosed herein. The network component 400 includes a processor 402 (e.g., CPU) that is in communication with memory devices including secondary storage 404, read only memory (ROM) 406, random access memory (RAM) 408, input/output (I/O) devices 410, and network connectivity devices 412. The processor 402 may be implemented as one or more central processing unit (CPU) chips, or may be part of one or more application specific integrated circuits (ASICs) and/or digital signal processors (DSPs).

The secondary storage 404 is typically comprised of one or more disk drives or tape drives and is used for non-volatile storage of data and as an over-flow data storage device if RAM 408 is not large enough to hold all working data. Secondary storage 404 may be used to store programs that are loaded into RAM 408 when such programs are selected for execution. The ROM 406 is used to store instructions and perhaps data that are read during program execution. ROM 406 is a non-volatile memory device that typically has a small memory capacity relative to the larger memory capacity of secondary storage 404. The RAM 408 is used to store volatile data and perhaps to store instructions. Access to both ROM 406 and RAM 408 is typically faster than to second storage 404.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising a processor configured to:
associate with a pharmacy or a doctor's office;
obtain information regarding a medication for a patient; and
send the information regarding the medication to a mobile device associated with the patient.

2. The apparatus of claim 1, wherein the processor is further configured to determine whether any of a plurality of medications associated with the patient interact with each other.

3. The apparatus of claim 1, wherein the apparatus is configured to communicate with a second pharmacy or a second doctor's office via a network, and wherein the apparatus is configured to send the information regarding the medication to the second pharmacy or the second doctor's office.

4. The apparatus of claim 1, wherein the apparatus is configured to communicate with a medication management database via a network, and wherein the apparatus is configured to send the information regarding the medication to the medication management database.

5. The apparatus of claim 1, wherein the processor is further configured to authenticate the mobile device prior to sending the information regarding the medication.

6. The apparatus of claim 1, wherein the information regarding the medication is sent to the mobile device via an Institute of Electrical and Electronics Engineers 802.11 compliant wireless link, a cellular link, or an Internet.

7. The apparatus of claim 1, wherein the information regarding the medication is sent to the mobile device via a Bluetooth link, a near field communication (NFC) link, or an Infrared Data Association (IrDa) interface.

8. A method for medication management comprising:
associating with a pharmacy or a doctor's office;
obtaining information regarding a medication for a patient; and
sending the information regarding the medication to a mobile device associated with the patient.

9. The method of claim 8, further comprising determining whether any of a plurality of medications associated with the patient interact with each other.

10. The method of claim 8, further comprising:
communicating with a second pharmacy or a second doctor's office via a network; and
sending the information regarding the medication to the second pharmacy or the second doctor's office.

11. The method of claim 8, further comprising:
communicating with a medication management database via a network; and
sending the information regarding the medication to the medication management database.

12. The method of claim 8, further comprising authenticating the mobile device prior to sending the information regarding the medication.

13. The method of claim 8, wherein the information regarding the medication is sent to the mobile device via an Institute of Electrical and Electronics Engineers 802.11 compliant wireless link, a cellular link, or an Internet.

14. The method of claim 8, wherein the information regarding the medication is sent to the mobile device via a Bluetooth link, a near field communication (NFC) link, or an Infrared Data Association (IrDa) interface.

15. A non-transitory computer-readable medium having computer usable instructions stored thereon for execution by a processor, wherein the instructions cause the processor to:
associate with a pharmacy or a doctor's office;
obtain information regarding a medication for a patient; and
send the information regarding the medication to a mobile device associated with the patient.

16. The non-transitory computer readable medium of claim 15, wherein the instructions further cause the processor to determine whether any of a plurality of medications associated with the patient interact with each other.

17. The non-transitory computer readable medium of claim 15, wherein the instructions further cause the processor to:
communicate with a second pharmacy or a second doctor's office via a network; and
send the information regarding the medication to the second pharmacy or the second doctor's office.

18. The non-transitory computer readable medium of claim 15, wherein the instructions further cause the processor to:
communicate with a medication management database via a network; and
send the information regarding the medication to the medication management database.

19. The non-transitory computer readable medium of claim 15, wherein the instructions further cause the processor to authenticate the mobile device prior to sending the information regarding the medication.

20. The non-transitory computer readable medium of claim 15, wherein the information regarding the medication is sent to the mobile device via an Institute of Electrical and Electronics Engineers 802.11 compliant wireless link, a cellular link, an Internet, a Bluetooth link, a near field communication (NFC) link, or an Infrared Data Association (IrDa) interface.
